(19) United States
(12) Patent Application Publication
(10) Pub. No.: US 2017/0209765 A1
(43) Pub. Date: Jul. 27, 2017

(54) CLUB STROKE ALIGNMENT TOOL

(71) Applicant: Grip Analyzer LLC, Phoenix, AZ (US)

(72) Inventors: Theodore T. PURDY, Phoenix, AZ (US); Steve WHITE, Phoenix, AZ (US)

(73) Assignee: Grip Analyzer LLC, Phoenix, AZ (US)

(21) Appl. No.: 15/329,443

(22) PCT Filed: Jul. 26, 2015
(86) PCT No.: PCT/US15/42158

§ 371 Date: Jan. 26, 2017

Related U.S. Application Data
(60) Provisional application No. 62/029,454, filed on Jul. 26, 2014.

(51) Int. Cl. A63B 71/06; G09B 19/00; A63B 69/36

(52) U.S. Cl. CPC A63B 71/0619; A63B 69/3688; G09B 19/0038; A63B 2071/025

(57) ABSTRACT

A club stroke alignment tool is used to evaluate and modify a club stroke. The club stroke alignment tool includes a contact plate that is rotatably coupled to a base that is movable on a surface. When hit with a club, the club stroke alignment tool provides data about an amount of rotation of a clubface, discrepancy from a center strike, and swing trajectory. The data is compared to a predetermined standards to find one or more discrepancies. If discrepancies exist, the stoke is modified to reduce the discrepancies on the next impact between the club and the club stroke alignment tool.

### FIELD

Implementations are generally directed to a club stroke alignment tool and methods using the club stroke alignment tool, particularly a club stroke alignment tool for improving a player's precision club and ball sport performance.

### BACKGROUND

Precision club and ball sports such as golf, polo, baseball, and hockey involve complex motions. As used herein, a ball is an object the player wishes to hit with the club, such as a golf ball, a hockey puck, a softball, baseball, or a cricket ball. There are many parameters that affect a player's success at the game. The environmental parameters include, for example, the strength and direction of the wind, the temperature, humidity, and the level of friction on the ground (e.g., the type of grass on the fairway). The stroke parameters that determine a direction of trajectory of the ball include the clubface orientation, impact force direction, and club swing. An error in the club hold or swing dwarfs the player's skills and may cause physical injury.

Amateurs and athletes alike often find it challenging to develop the skill of having a proper stroke. Accordingly, it would be an advantage to provide a club stroke alignment tool to help players develop their skills in having a proper club hold, orientation, aim and swing.

### SUMMARY

In some embodiments, a golf stroke alignment tool comprises a contact segment, a base, and an indicator. The contact segment has a contact body with a proximal end configured to contact at least a portion of a golf club head of a golf club upon impact of the golf club head with the proximal end. The base is rotatably coupled to the contact body. The indicator is coupled to the contact body, wherein the indicator is configured to provide information about a rotation of the contact segment relative to the base.

In yet another implementation, a method for aligning a stroke for a desired ball trajectory includes receiving data about a golf stroke from a club stroke alignment tool. The club stroke alignment tool includes a contact segment, an indicator, and a base. The contact segment has a proximal end configured to engage at least a portion of a club head. The base is rotatably coupled to the contact segment. The indicator is coupled to the contact segment and is configured to provide information about a rotation of the contact segment relative to the base. The method further includes comparing the data about the club stroke to a predetermined standard to find a match. When there is a discrepancy between the data about the club stroke and the predetermined standard, a modification is determined for the club stroke to reduce the discrepancy for a subsequent club stroke.

In yet another implementation, a club stroke alignment tool includes a contact segment, an indicator, and abase that is rotatably coupled to the contact segment. The indicator is coupled to the contact segment and configured to provide information about an orientation of a clubface of a respective club upon impact of the clubface with the contact segment. The base is configured to provide information about a direction of a swing of the respective club upon the impact of the clubface with the contact segment.

### BRIEF DESCRIPTION OF THE DRAWINGS

Implementations will become more apparent from the detailed description set forth below when taken in conjunction with the drawings, in which like elements bear like reference numerals.

FIG. 1A is a side view of a golf club;

FIG. 1B is a close up side view of a golf club head and a trajectory of a ball upon impact;

FIGS. 2A-2B are each a schematic illustrating an effect of a rotated club head on a trajectory of a ball;

FIGS. 3A-3B and 4 are each a schematic illustrating the effect of a stroke force direction on a ball;

FIGS. 5A-5C are each a schematic illustrating respective club swings;

FIG. 6 is a perspective view of a club stroke alignment tool;

FIG. 7A is a top view of the club stroke alignment tool of FIG. 6;

FIG. 7B is a side view of the club stroke alignment tool of FIG. 6;

FIG. 7C is a back view of the club stroke alignment tool of FIG. 6;

FIG. 8A is a schematic of an articulated club stroke alignment tool;

FIGS. 9A-9C are each a schematic illustrating respective club strokes using a club stroke alignment tool; and

FIG. 10 is a flow chart of a method for aligning a golf stroke using a golf stroke alignment tool.

### DETAILED DESCRIPTION

Reference throughout this specification to “one embodiment,” “an embodiment,” “an implementation,” or similar language means that a particular feature, structure, or characteristic described in connection with the embodiment is included in at least one embodiment of the present invention. Thus, appearances of the phrases “in one embodiment,” “in an embodiment,” “in some embodiments,” “in certain embodiments,” and similar language throughout this specification may, but do not necessarily, all refer to the same embodiment.

The described features, structures, or characteristics of the technology may be combined in any suitable manner in one or more embodiments. In the following description, numerous specific details are recited to provide a thorough understanding of various embodiments. One skilled in the relevant art will recognize, however, that the technology may be practiced without one or more of the specific details, or with other methods, components, materials, and so forth. In other instances, well-known structures, materials, or operations are not shown or described in detail to avoid obscuring aspects of the technology.

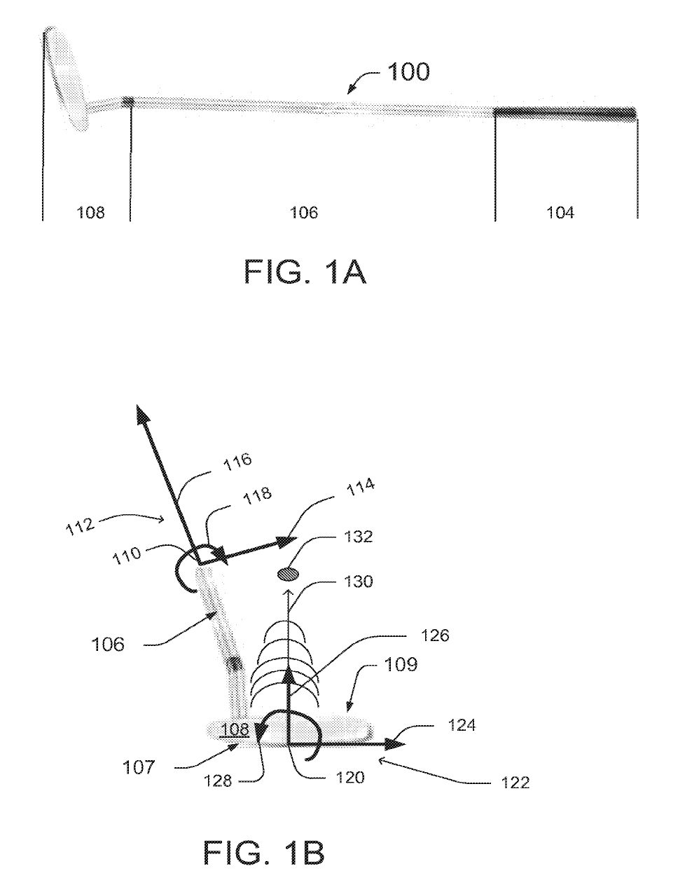

Referring to FIGS. 1A and 1B, a club, shown as golf club 100, includes a grip 104, a shaft 106, and a club head 108. Although FIGS. 1A and 1B illustrate a golf club, any club used in a precision club and ball sport is applicable; for example, a club with a flat clubface, such as a hockey club, is applicable. The shaft 106 is illustrated with a shaft coordinate system 112 having an shaft origin at 110, a shaft x-axis 114, a shaft y-axis 116, and a shaft z-axis 118. The shaft coordinate system 112 is rotated relative to a ball coordinate system 122, which has its own ball origin 120, ball x-axis 124, ball y-axis 126, and ball z-axis 128. The translational and rotational relationship between the shaft and ball coordinate systems is mathematically determinable through coordinate transformation equations.

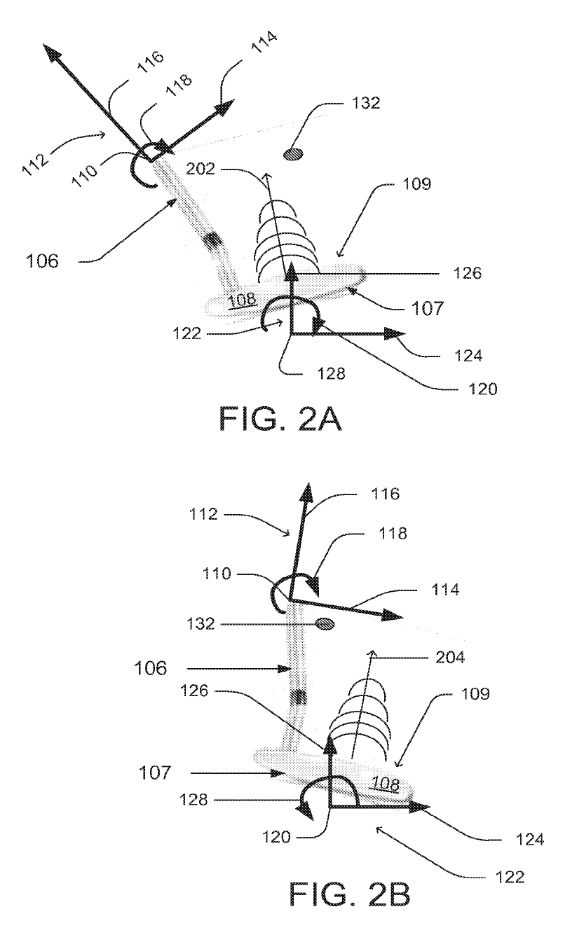

In the golf example illustrated in FIG. 1B, when the bottom surface 107 of the club head 108 lies flat on the ground and the clubface 109 hits the center of the ball, the trajectory 130 of the ball is directed towards the target 132. However, lack of a proper relationship between the shaft 106 (and thus the clubface) and the ball (e.g., the shaft coordinate system 112 and/or the ball coordinate system 122) results in errors in the trajectory 130 of the ball. Referring to FIGS. 2A-2B, schematics illustrated exemplary mis-positioning of the shaft coordinate system 112 relative to the ball coordinate system 122 resulting in a missed target 132. In FIG. 2A, the shaft 106 (and consequently the clubface 109) is rotated counterclockwise about the shaft z-axis 118, resulting in the trajectory 202 that is left of the target 132. In FIG. 2B, the shaft 106 (and consequently the clubface 109) is rotated clockwise about the shaft z-axis 118, resulting in the trajectory 204 that is right of the target 132. Alternatively, or in combination, similar mis-positioning of the shaft coordinate system 112 and the ball coordinate system 122 can occur due to rotations about the shaft x-axis 114 and/or the shaft y-axis 116, resulting in missing the target 132 (not shown).

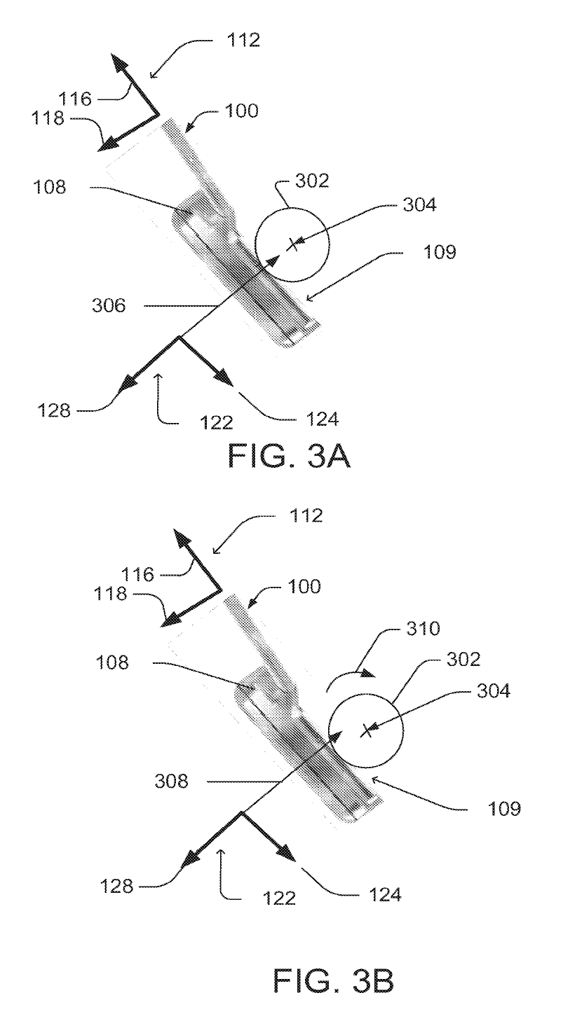

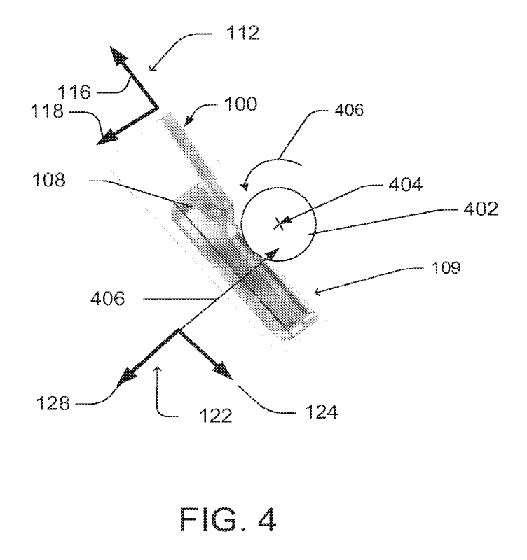

Referring to FIGS. 3A, 3B and 4, a spin is produced on the ball 302 when the clubface 109 does not produce a center strike, but hits the ball 302 off center due to translation of the clubface 109 in the ball x-axis 124 direction. Such an unintentional spin on the ball 302 can result in a missed target. In FIG. 3A, a schematic illustrates a first positioning of the club head 108 relative to the ball 302, and consequently between the shaft coordinate system 112 and the ball coordinate system 122 (shaft x-axis 114 and ball y-axis 126 not shown for ease of illustration). Here, a swing of the club 100, and consequently the club head 108, produces a force 306 that is directed towards the center 304 of the ball 302 such that the ball 302 takes flight without a spin (“center strike”). Conversely, in FIGS. 3B and 4, a translation of the club head 108 along the ball x-axis 124 produces a spin on the ball 302 upon impact. In FIG. 3B a translation of the club head 108 backwards along the ball x-axis 124 produces a clockwise spin 310 on the ball 302 because the direction of force 308 is to the left of the center 304 of the ball 302. In FIG. 4 a translation of the club head 108 forward along the ball x-axis 124 produces a counterclockwise spin 406 on the ball 402 because the direction of force 406 is to the right of the center 304 of the ball 402.

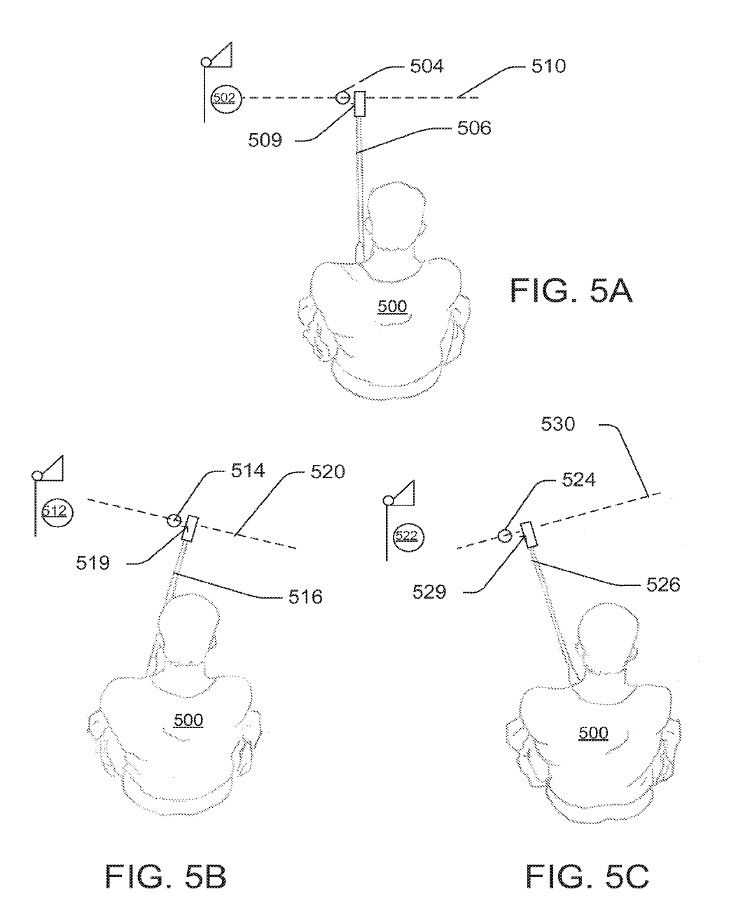

Another parameter that affects a club stroke is the swing. Referring to FIGS. 5A-5C, a plurality of respective swings are illustrated. In FIG. 5A, a player 500 places the clubface 509 of a club 506 perpendicular to the designed path 510 between the ball 504 and a target 502. Assuming there is no effect from elevation or wind, if the player 500 swings the club 506 from right to left along the desired path 510, the ball 504 will follow the desired path 510 towards the target 502 upon impact. However, if the swing is misdirected, the ball 504 will miss the target 502 even if the clubface 509 is perpendicular to desired path 510 in FIG. 5A. To illustrate, in FIGS. 5B and 5C, the player 500 swings from right to left along the trajectories 520 and 530, respectively, each of which are not collinear with the desired path 510. Consequently, the balls 514 and 524 respectively follow the corresponding trajectory 520 and 530 upon impact and will miss the corresponding targets 512 and 522 even though the clubface 509 is perpendicular to the respective trajectories, 520 and 530.

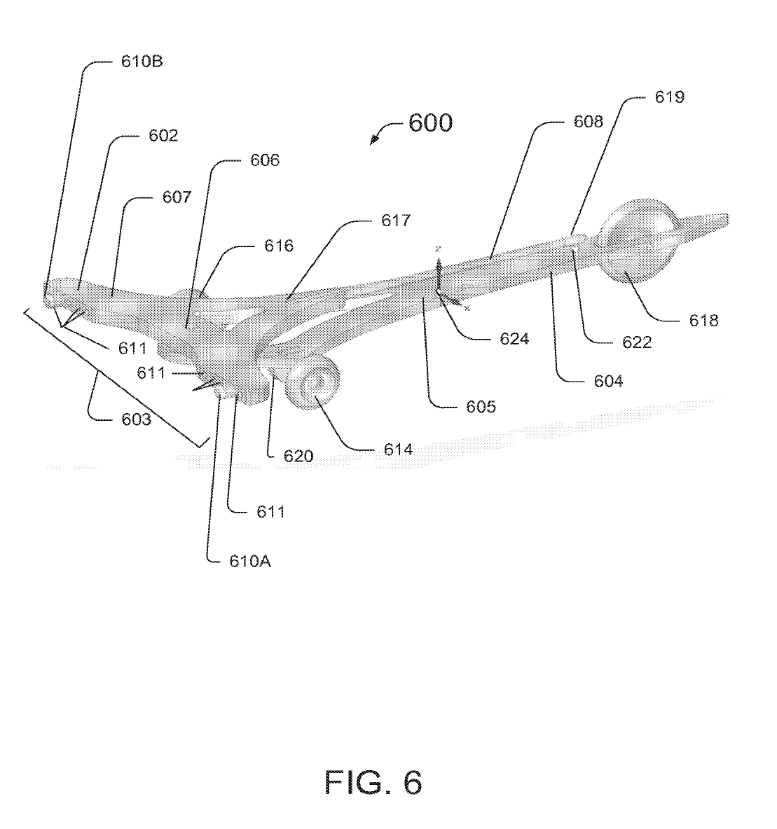

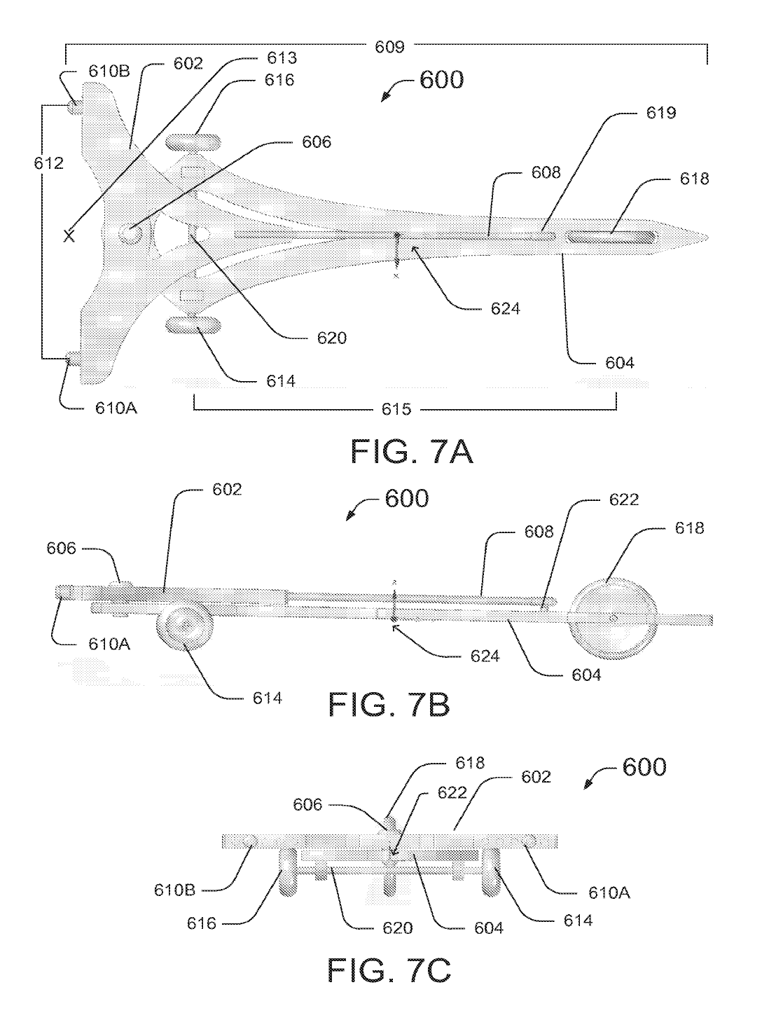

Referring to FIGS. 6 and 7A-7C, schematics illustrate an exemplary club stroke alignment tool 600 (also referred to as a club stroke alignment apparatus). In some embodiments, the club stroke alignment tool 600 includes a contact segment coupled to each of a base 604 and an indicator 608. In FIG. 6, the contact segment is shown as a substantially planar contact plate 602 having a contact body 607, also referred to as “body of contact segment” 607 with a proximal end 603 and a distal end 617. The club stroke alignment tool 600 has a tool coordinate system 624.

The base 604 has a base body 605, here shown as substantially planar with a triangular shape. In certain embodiments, the base 604 includes a motion means that allows movement on a surface, such as translation of the club stroke alignment tool 600 within a tool x-axis and tool y-axis plane. For example, the base 604 includes rollers configured to allow motion on a surface when hit with a club. As illustrated in FIGS. 6 and 7A-7C, the rollers are three wheels 614, 616 and 618 that are positioned into a triangular formation. The back wheels 614 and 616 are coupled to the base 604 via an axle carrier 620. The back wheels 614 and 616 are smaller than the center wheel 618 to allow for unobstructed rotation of the contact plate 602 relative to the base 604. Other planar motion means are also contemplated such as using spherical balls instead of wheels or a cylinder instead of back wheels 614 and 616.

Yet another example of a means for motion includes an air projection plate that sits under the club stroke alignment tool 600. The air projection plate injects pressurized air towards the club stroke alignment tool 600 such that the club stroke alignment tool 600 floats above the plate and is capable of translation within the tool x-axis and tool y-axis plane, for example.

The contact plate 602 is coupled to the base 604 in a manner that restricts translation of the contact plate 602 relative to the base 604. In certain embodiments, the contact body 607 of the contact plate 602 is rotatably coupled to the base 604 such that tool x-axis rotation of the contact body 607 relative to the base 604 is substantially restricted and tool y-axis rotation of the contact body 607 relative to the base 604 is substantially restricted but tool z-axis rotation of the contact body 607 relative to the base 604 is not restricted.

In the illustrated example, the contact plate 602 is pivotally coupled to the base 604 by a pivot 606. For example, the pivot 606 has small bearings to allow for tool z-axis rotation while minimizing friction between the contact plate 602 and the base 604. Other means for coupling are also contemplated such as by magnetic coupling or mechanical coupling, such as by a lubricated conical pivot.

The proximal end 603 of the contact body 607 is adapted to contact or engage with at least a portion of the club head (not shown). Other configurations for the contact body 607 are also contemplated. For example, in certain embodiments, the contact body 607 has a convex shape.

In certain embodiments, the contact plate 602 is coupled to an indicator, shown as indicator 608, at the distal end 617 of the contact body 607. In this example of FIG. 6, the indicator is a substantially cylindrical pointer 608, other configurations are also contemplated. The indicator visually displays an orientation of the contact plate 602 relative to the base 604. In FIG. 6, the pointer 608 is affixed to the distal end 617 of the contact body 607 of the contact plate 602 and remains stationary relative to the contact plate 602 but not stationary relative to the base 604. Here, the long axis of the pointer 608 is aligned with the tool y-axis 622 when not rotated. When the contact plate 602 is rotated about the tool z-axis at the pivot 606, the orientation of the indictor visually displays the rotation angle of the contact plate 602 relative to the base 604. Other forms of indicators which measure and/or display the orientation of the contact plate 602 relative to the base 604 are also contemplated, such as a dial gauge, a digital indicator, and the like.

In some embodiments, the club stroke alignment tool 600 includes a calibration system. For example, a magnet 622 is affixed to the base body 605 of the base 604 situated under a tip 619 of the pointer 608. At the distal end of the pointer 608, a metallic piece or metallic coating magnetically couples the pointer 608 to the magnet 622. This keeps the contact plate 602 from rotating about the pivot 606 prior to impact from a club head.

In certain embodiments, the contact plate 602 includes one or more impact buffers at its proximal end 603. In FIGS. 6 and 7A-7C, the impact buffers are illustrated as rubber bumpers 610A and 610B that are each adjustable. Other materials for the impact buffers are also contemplated, such as wood, plastic, metal, and the like. Although only two rubber bumpers 610A and 610B are illustrated, more or less rubber bumpers are also contemplated. The rubber bumpers 610A and 610B are removable such that they can be placed into any of a plurality of apertures 611 (e.g., holes) in order to adjust the distance 612 between the impact buffers to match the width of a club head (not shown). The halfway point 613 in the distance 612 represents the desired location of an impact force for a center strike. If the club head misses one or more of the impact points during impact (e.g., when the club head engages with the ball) of the club head with the contact plate 602, then the club head is not positioned for a center strike. In certain embodiments, an off-center strike produces a rotation of the contact plate 602 about the tool z-axis and the pointer 608 rotates visually indicating the off-center impact.

Other forms of impact buffers are also contemplated. For example, in some embodiments the impact buffers include sensors that detect a level of compression force or pressure at each sensor (e.g., strain gauges or piezoelectric sensor). A value for each of the compression forces/pressures and/or a comparison of the values is then displayed to the player, such as by an electronic display. When the compression forces/pressures are not equal between the two sensors then the club head is not positioned for a center strike.

In certain embodiments, of the club stroke alignment tool 600, such as one or more of the contact plate 602 and the base 604 is made of natural and/or synthetic material, such as metal, wood, plastic or a combination thereof. Exemplary dimensions for the components of the club stroke alignment tool 600 are as follows:

| Component description | Dimension in inches |
|---|---|
| Contact Plate 602 Proximal End 603 | About between 6 to 12 inches |
| impact buffer distance 612 | |
| Club stroke alignment tool 600 length 609 | About between 6 to 18 inches |
| Wheel to wheel length 615 | About between 6 to 12 inches |

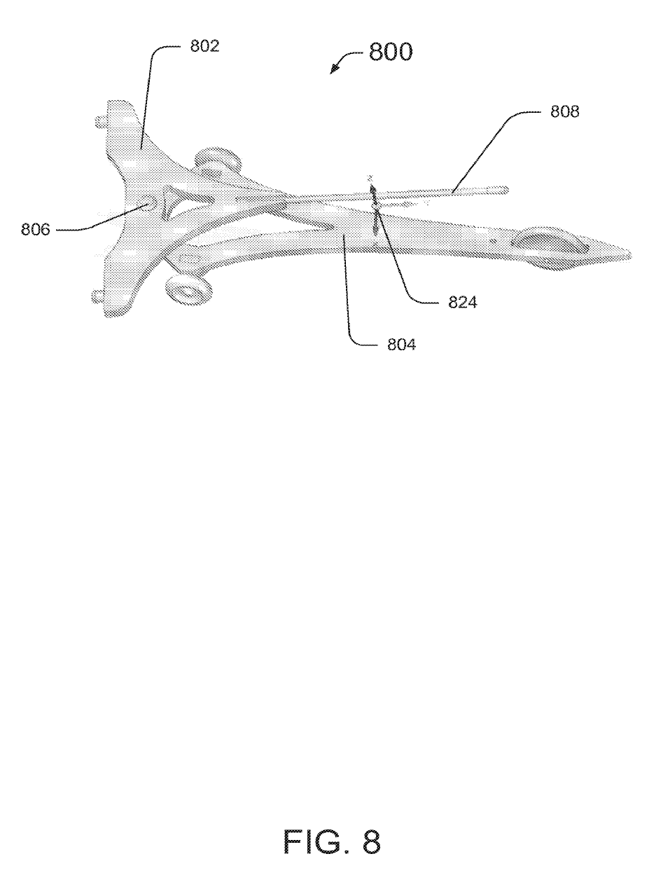

Referring to FIG. 8, an articulated club stroke alignment tool 800 shows the pointer 808 rotated about the tool z-axis of the tool coordinate system 824. Here, the contact plate 802 has rotated in the counterclockwise direction relative to the base 804. In certain embodiments, the rotation of the pointer 808 is due to at least one of: a clubface that is not oriented for a center strike, a clubface that is rotated relative to club stroke alignment tool 800 contact plate orientation, and a swing that produces a trajectory different from the desired path for the ball.

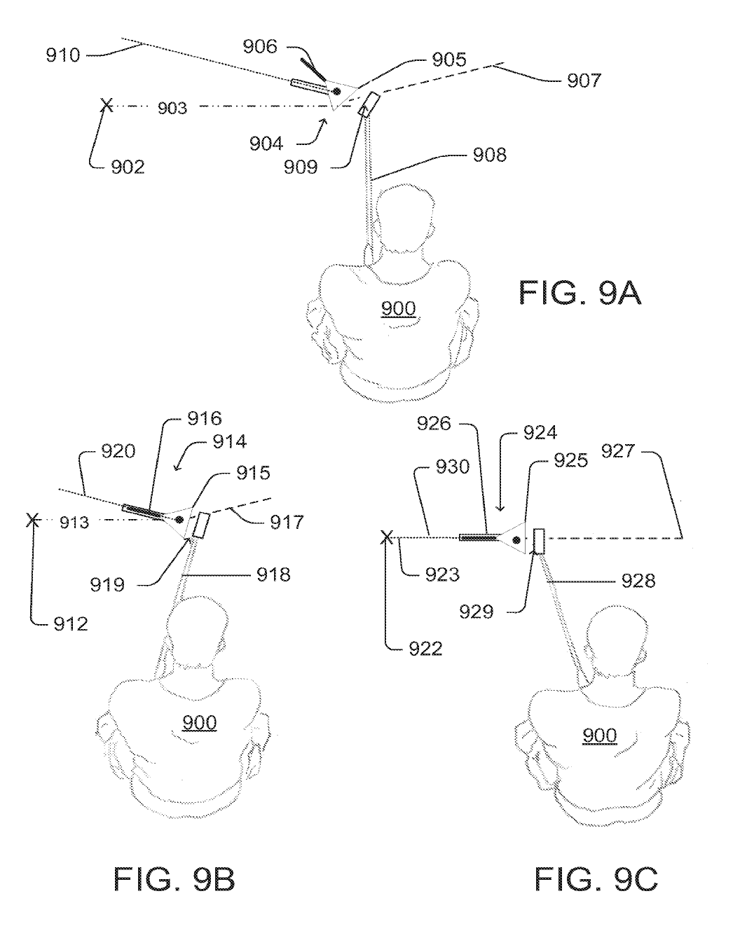

In certain embodiments, the club stroke alignment tool 800 provides for parameters of a stroke, such as a center strike, clubface orientation, and swing trajectory to be, at least one of: independently discernable, evaluated/determined, and modified/corrected. Referring to FIGS. 9A-9C, a player 900 uses one or more club stroke alignment tools to improve his club stroke. To illustrate, and referring to FIG. 9A, a player 900 has mistakenly oriented a clubface 909 of a club 908 at an angle that is different from being substantially perpendicular to a desired path 903 towards the target 902. Moreover, the player's swing produces a trajectory 907 that is angled downward, from an upper right to a lower left, relative to the desired path 903. Due to the swing trajectory 907, when the club 908 engages (e.g., hits) the club stroke alignment tool 904, the club stroke alignment tool 904 the moves in a direction 910. Moreover, due to the clubface 909 rotated orientation, a contact plate 905 of the club stroke alignment tool 904 rotates relative to its base. An indicator 906 affixed to the contact plate 905 veers to the right, visually showing a value of the clockwise rotation. Consequently, the stroke parameters of clubface and swing are independently discernable. Here, the player 900 deduces from the travel direction 910 that his swing was angled from an upper right to a lower left relative to the desired path 903. Moreover, the player 900 deduces from the indicator 906 clockwise rotation that his clubface 909 was rotated clockwise relative to the desired path 903. The player 900 then modifies his stroke based on this evaluation.

Referring to FIG. 9B, the player 900 attempts a modified stroke. Here, he has orients a clubface 919 of a club 918 substantially perpendicular to a desired path 913 towards the target 912. An indicator 916 affixed to contact plate 915 remains substantially stationary relative to the base due to the correct orientation of the clubface 929 during impact. However, in this example, the player's swing was still misdirected. His swing has a trajectory 917 that is angled downward, from an upper right to a lower left, relative to the desired path 913. The trajectory 917 of the swing causes the club stroke alignment tool 914 to travel in a direction 920 when the club 918 engages (e.g., hits) the club stroke alignment tool 914. Here, the player 900 deduces from the non-rotated indicator 916 that his clubface 919 was correctly oriented but his swing was angled from an upper right to a lower left relative to the desired path 913 based on the travel direction 920. The player 900 then modifies his stroke based on this evaluation.

In FIG. 9C, the player has corrected both his clubface 929 and swing trajectory 927. Here, at impact, the clubface 929 is substantially perpendicular to the desired path 923 towards a target 922. Consequently, the indicator 926 has not rotated. Moreover, given that the player's 900 swing trajectory 927 is colinear from the desired path 913 the club stroke alignment tool 924 travel direction 930 is also collinear with the desired path 923. Consequently, the player's 900 stroke has been corrected and the target 922 meet.

Similarly, an off-center strike is independently discernable, evaluated/determined, and modified/corrected in certain embodiments. Referring to FIGS. 9C and 7A, if the player 900 misses one or more of the rubber bumpers 610A and 610B, the player 900 detects the off-center strike of the club stroke alignment tool 600/924 via the reaction force produced on the club by the club stroke alignment tool 600/924 due to the off-center strike.

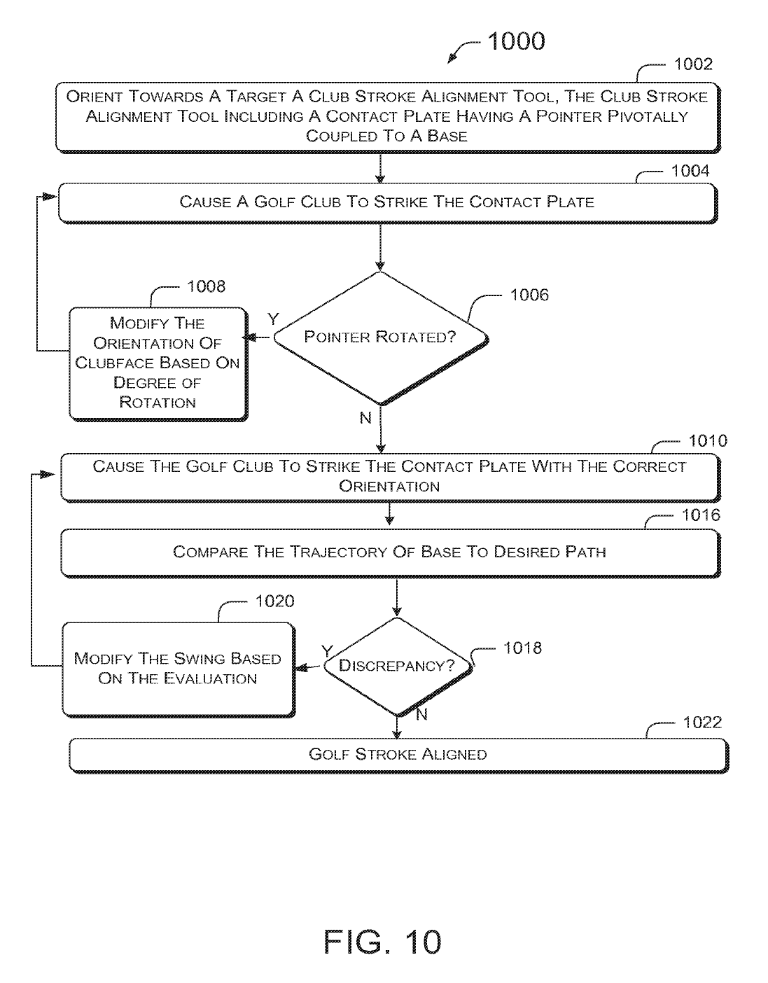

Referring to FIG. 10, a flow chart illustrates a method 1000 for improving a golf stroke using an exemplary club stroke alignment tool, also referred to as golf stroke alignment tool. In certain embodiments, one or more steps of method 1000 is practiced by at least one of: a player (e.g., a golfer), an instructor of the player that instructs the player accordingly, a sales person illustrating use of various golf clubs, and a computer program encoded on a non-transitory computer readable medium that is processed by a processor of a computing device.

At step 1002, a golf stroke alignment tool is oriented towards a target such that the proximal end of the golf stroke alignment tool is towards a golfer's golf club and the distal end of the golf stroke alignment tool is pointed towards the target. At step 1004, the golf club strikes the contact plate of the golf stroke alignment tool. For example, the instructor asks a golfer to swing and hit the golf stroke alignment tool. At step 1006, a determination is made on whether the indicator, here a “pointer” has rotated such that it does not match a predetermined standard, such as a predetermined standard of a zero rotation. If there is no discrepancy, such as when the pointer has not rotated, the method 1000 moves from step 1006 to 1010. If there is a discrepancy (e.g., the pointer is rotated), the method 1000 moves from step 1006 to step 1008. At step 1008, the orientation of the clubface is modified based on the degree of rotation and steps 1004 and 1006 are repeated. To illustrate, if the pointer is rotated clockwise after impact, then the pointer is indicating a discrepancy from predetermined standards such as a center strike and/or having the plane of the clubface be perpendicular to the desired path for the ball. A missed center strike problem causes a sudden rotation of the clubface at impact, which is felt by the player and thus often distinguishable from a rotation of the clubface due to an erroneous club hold. At least one of the orientation and aim of the clubface are, in turn, modified and the golfer strikes the golf stroke alignment tool again using the modification.

At step 1010, the golfer is instructed to and/or strikes the alignment tool with the correct orientation of the clubface such that the pointer does not rotate. At step 1016, the trajectory of the golf stroke alignment tool, such as the trajectory of the base of the golf stroke alignment tool, is compared to the desired path. At step 1018, if there is no discrepancy then the method 1000 moves to step 1022 where the swing and clubface orientation is determined to be accurate and the golf stroke aligned. If there is a discrepancy at step 1018, then the method 1000 moves to step 1020. At step 1020 the swing is modified based on the degree of discrepancy between the trajectory of the base and the desired path and steps 1010, 1016, and 1018 are repeated.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in a non-transitory computer readable medium that can be loaded onto a general purpose computer, a special purpose computer, or other programmable apparatus.

It is understood that the examples and implementations described herein are for illustrative purposes only and that various modifications or changes in light thereof will be suggested to persons skilled in the art and are to be included within the spirit and purview of this application.

We claim:

1. A golf stroke alignment tool comprising:
a contact segment having a contact body with a proximal end, wherein the proximal end is configured to contact at least a portion of a golf club head of a golf club upon impact of the golf club head with the proximal end;
a base rotatably coupled to the contact body; and
an indicator coupled to the contact body, wherein the indicator is configured to provide information about a rotation of the contact segment relative to the base.

2. The golf stroke alignment tool of claim 1, wherein the indicator is configured to visually depict the rotation of the contact segment about an axis that is substantially perpendicular to a plane of the contact body.

3. The golf stroke alignment tool of claim 1, wherein the base pivotally coupled to the contact body has an axis of rotation that is located at a halfway point of the proximal end.

4. The golf stroke alignment tool of claim 1, further comprising one or more rollers coupled to the base, wherein the rollers are configured to move the base on a surface.

5. The golf stroke alignment tool of claim 1, further comprising one or more impact buffers removably coupled to the proximal end of the contact body.

6. The golf stroke alignment tool of claim 5, wherein an axis of rotation of the rotatably coupled contact segment and base is aligned with a halfway point between two of the impact buffers and a long axis of a cylindrical said indicator.

7. The golf stroke alignment tool of claim 1, further comprising a magnet affixed to the base at a location directly under a tip of the indicator, wherein:
the indicator has a cylindrical indicator body with the tip at one end of the cylindrical indicator body; and
the tip is at least partially metallic.

8. A method for aligning a club stroke for a desired ball trajectory, the method comprising:
receiving, from a club stroke alignment tool, data about a club stroke, wherein the club stroke alignment tool comprises:
a contact segment having a proximal end configured to engage at least a portion of a respective club head;
a base rotatably coupled to the contact segment; and
an indicator coupled to the contact segment, wherein the indicator is configured to provide information about a rotation of the contact segment relative to the base;
comparing the data about the club stroke to a predetermined standard to find a match; and
when there is a discrepancy between the data about the club stroke and the predetermined standard, determining a modification to the club stroke to reduce the discrepancy for a subsequent said club stroke.

9. The method of claim 8, wherein the data about the club stroke includes:
the information from the indicator about the rotation of the contact segment relative to the base; and
a trajectory of the base after the proximal end has engaged with the at least a portion of the respective club head.

10. The method of claim 8, further comprising using the data about the club stroke to determine at least one of an orientation of the club head and a club swing.

11. The method of claim 10, wherein the modification includes a change to at least the orientation of the club head and the club swing.

12. The method of claim 8, wherein the steps of receiving, comparing, and determining are computer program instructions encoded on a non-transitory medium and executed by a processor of a computing device.

13. A club stroke alignment tool comprising:
a contact segment;
an indicator, coupled to the contact segment, configured to provide information about an orientation of a clubface of a respective club upon impact of the clubface with the contact segment; and
a base rotatably, coupled to the contact segment, configured to provide information about a direction of a swing of the respective club upon the impact of the clubface with the contact segment.

14. The club stroke alignment tool of claim 13, further comprising one or more impact buffers removably coupled to a proximal end of the contact segment.

15. The club stroke alignment tool of claim 14, wherein an axis of rotation of the rotatably coupled contact segment and base is aligned with a halfway point between two of the impact buffers and a long axis of a cylindrical said indicator.

16. The club stroke alignment tool of claim 13, wherein the indicator is configured to visually depict a rotation of the contact segment, relative to the base, about an axis that is substantially perpendicular to a plane of the contact segment.

17. The club stroke alignment tool of claim 13, further comprising one or more rollers coupled to the base.

18. The club stroke alignment tool of claim 17, wherein the roller are configured to not impede the rotation of the contact segment relative to the base.

19. The club stroke alignment tool of claim 13, further comprising a magnet affixed to the base at a location directly under a tip of the indicator, wherein:
the indicator has a cylindrical body with the tip at one end of the body; and
the tip of the indicator is at least partially metallic.

20. The club stroke alignment tool of claim 13, wherein the contact segment has a planar body with a proximal end that is configured to engage, upon impact, at least a portion of a clubface.
